(19) United States
(12) Patent Application Publication
(10) Pub. No.: US 2026/0351251 A1
(43) Pub. Date: Nov. 5, 2026

(54) SEMANTIC VAD: AN LLM-BASED DIALOGUE MANAGER FOR FULL-DUPLEX COMMUNICATION IN SPOKEN DIALOGUE SYSTEMS

(71) Applicant: TENCENT AMERICA LLC, Palo Alto, CA (US)

(72) Inventors: Hao ZHANG, Columbus, OH (US); Vinay Kothapally, Palo Alto, CA (US); Meng Yu, Palo Alto, CA (US); Dong Yu, Palo Alto, CA (US)

(73) Assignee: TENCENT AMERICA LLC, Palo Alto, CA (US)

(21) Appl. No.: 19/180,234

(22) Filed: Apr. 16, 2025

(51) Int. Cl. G10L 15/183; G10L 15/18; G10L 15/22; G10L 25/78

(52) U.S. Cl. CPC G10L 15/183; G10L 15/1815; G10L 15/222; G10L 25/78

(57) ABSTRACT

A method and apparatus comprising computer code configured to cause a processor or processors to receive an audio input, implement, by semantic voice activity detection (VAD) of a dialog manager (DM) trained as a first large language model (LLM), any of a user state detection and a user intention analysis, determine, by the DM and depending on a result of any of the user state detection and the user intention analysis, whether to activate at least part of a core dialog engine (CDE) to process the audio input, and control, by the CDE in response to being activated by the DM, output of a response to any of the query spoken by the user and the other verbal input as a result of the DM determining that the any of the query spoken by the user and the other verbal input requires response from the SDS.

### BACKGROUND

### 1. Field

This disclosure relates to improvements in both real-time responsiveness and computational overhead in context of large language models (LLMs).

### 2. Description of Related Art

Spoken dialogue systems (SDSs) have advanced significantly with LLMs, enabling more natural and context-aware interactions. However, achieving full-duplex communication, where SDS can listen and speak simultaneously, has been technically challenging.

Many SDSs still operate in a turn-based (half-duplex) or “pseudo” fullduplex manner, leading to less fluid interactions due to lack of understanding of the user's state and intention. In contrast, human conversations involve seamless turn-taking. Beyond turn-taking, a full-duplex SDS must handle challenges like interfering speakers, user hesitations, and distinguishing between intentional and unintentional interruptions to improve naturalness and efficiency.

Achieving full-duplex communication in SDS has been widely studied. Early approaches relied on separate neural network modules for detection and classification tasks, limiting stability and robustness. Speech event detection may be used for real-time query updates but lacks broader interaction handling. Duplex Conversation technology may leverage a multimodal model for user state detection and turn management. Recent methods embed interaction handling directly into LLMs, improving automation but increasing inference overhead. NeuralFSM, fine-tuning an LLM with a finite state machine (FSM) for synchronized speaking and listening, may be applied. Similarly, finetuning an LLM with a time-division multiplexing strategy for duplex dialogue has been studied. Further, any of state tokens and a duplex scheme for non-awakening and audio-interrupt interactions, integrating a base LLM with a smaller Transformer for real-time streaming predictions, and RTTL-DG, a textless spoken dialogue model incorporating backchannels and laughter for natural turn-taking may be employed.

Nonetheless, real-time responsiveness and computational overhead have remained significant technical challenges. And aspects of this disclosure provide improvements in both senses.

### SUMMARY

There is included a method and apparatus comprising memory configured to store computer program code and a processor or processors configured to access the computer program code and operate as instructed by the computer program code. The computer program is configured to cause the processor implement receiving code configured to cause the one or more processors to receive an audio input, the audio input comprising any of at least part of a query spoken by a user and an other verbal input received by the SDS; implementing code configured to cause the one or more processors to, by semantic voice activity detection (VAD) of a dialog manager (DM) trained as a first large language model (LLM), implement any of a user state detection and a user intention analysis, the DM being trained as the first LLM both to, as the user state detection, determine from the audio input whether the user has finished speaking the query and also to, as the user intention analysis, determine whether a user barge-in represented by the other verbal input requires a response; determining code configured to cause the one or more processors to, by the DM and depending on a result of any of the user state detection and the user intention analysis, determine whether to activate at least part of a core dialog engine (CDE) to process the audio input, the CDE being trained as a second LLM that is larger than the first LLM; and controlling code configured to cause the one or more processors to, by the CDE in response to being activated by the DM, control output of a response to any of the query spoken by the user and the other verbal input as a result of the DM determining that the any of the query spoken by the user and the other verbal input requires response from the SDS.

There is also provided a method of a speech detection system (SDS), the method being implemented by one of more hardware processors and including: receiving an audio input, the audio input comprising any of at least part of a query spoken by a user and an other verbal input received by the SDS; implementing, by semantic voice activity detection (VAD) of a dialog manager (DM) trained as a first large language model (LLM), any of a user state detection and a user intention analysis, the DM being trained as the first LLM both to, as the user state detection, determine from the audio input whether the user has finished speaking the query and also to, as the user intention analysis, determine whether a user barge-in represented by the other verbal input requires a response; determining, by the DM and depending on a result of any of the user state detection and the user intention analysis, whether to activate at least part of a core dialog engine (CDE) to process the audio input, the CDE being trained as a second LLM that is larger than the first LLM; and controlling, by the CDE in response to being activated by the DM, output of a response to any of the query spoken by the user and the other verbal input as a result of the DM determining that the any of the query spoken by the user and the other verbal input requires response from the SDS.

Of the method, the DM may implement the user state detection by determining whether the audio input represents any of an incomplete query of the user and a complete query of the user, and the DM may be configured to select one of a continue-listening token, based on the user state detection resulting in a determination that the audio input represents the incomplete query, and a start-speaking token, based on the user state detection resulting in a determination that the audio input represents the complete query.

Of the method, the DM, based on selecting the continue-listening token as a result of the user state detection, may both control the SDS to, without activating the CDE, continue a listening process and cache any received queries during the listening process until at least the complete query is determined by the user state detection of the DM, and the DM, based on selecting the start-speaking token as the result of the user state detection, may both control activation of the CDE to process and output the response to the complete query and also to transition from the selection of the start-speaking token to selection of a start-listening token in response to the CDE finishing outputting the response to the complete query.

Of the method, the DM may implement the user intention analysis by determining whether the audio input represents any of an intentional interruption of the user and an unintentional interruption of the user, and the DM may be configured to select one of the start-listening token, based on the user intention analysis resulting in a determination that the audio input represents a user intention to redirect a conversation with the SDS, and a continue-speaking token, based on the user intention analysis resulting in a determination that the audio input does not represent the user intention to redirect the conversation with the SDS.

Of the method, the DM, based on selecting the start-speaking token as a result of the user intention analysis, may control a stop of an outputting of the response by the CDE and a restart of the listening process by the DM, and the DM, based on selecting the continue-speaking token as the result of the user intention analysis, may control the CDE to continue the outputting of the response by the CDE.

Of the method, the DM may implement the user intention analysis by determining whether the audio input represents any of an intentional interruption of the user and an unintentional interruption of the user, and the DM may be configured to select one of a start-listening token, based on the user intention analysis resulting in a determination that the audio input represents a user intention to redirect a conversation with the SDS, and a continue-speaking token, based on the user intention analysis resulting in a determination that the audio input does not represent the user intention to redirect the conversation with the SDS.

Of the method, the DM, based on selecting the start-speaking token as a result of the user intention analysis, may control a stop of an outputting of the response by the CDE and a restart of a listening process by the DM, and the DM, based on selecting the continue-speaking token as the result of the user intention analysis, may control the CDE to continue the outputting of the response by the CDE.

There is also provided an apparatus of a speech detection system (SDS), the apparatus including: one or more memories configured to store computer program code; and one or more processors configured to access the computer program code and operate as instructed by the computer program code, the computer program code including: receiving code configured to cause the one or more processors to receive an audio input, the audio input comprising any of at least part of a query spoken by a user and an other verbal input received by the SDS; implementing code configured to cause the one or more processors to, by semantic voice activity detection (VAD) of a dialog manager (DM) trained as a first large language model (LLM), implement any of a user state detection and a user intention analysis, the DM being trained as the first LLM both to, as the user state detection, determine from the audio input whether the user has finished speaking the query and also to, as the user intention analysis, determine whether a user barge-in represented by the other verbal input requires a response; determining code configured to cause the one or more processors to, by the DM and depending on a result of any of the user state detection and the user intention analysis, determine whether to activate at least part of a core dialog engine (CDE) to process the audio input, the CDE being trained as a second LLM that is larger than the first LLM; and controlling code configured to cause the one or more processors to, by the CDE in response to being activated by the DM, control output of a response to any of the query spoken by the user and the other verbal input as a result of the DM determining that the any of the query spoken by the user and the other verbal input requires response from the SDS.

Of the apparatus, the DM may implement the user state detection by determining whether the audio input represents any of an incomplete query of the user and a complete query of the user, and the DM may be configured to select one of a continue-listening token, based on the user state detection resulting in a determination that the audio input represents the incomplete query, and a start-speaking token, based on the user state detection resulting in a determination that the audio input represents the complete query.

Of the apparatus, the DM, based on selecting the continue-listening token as a result of the user state detection, may both control the SDS to, without activating the CDE, continue a listening process and cache any received queries during the listening process until at least the complete query is determined by the user state detection of the DM, and the DM, based on selecting the start-speaking token as the result of the user state detection, may both control activation of the CDE to process and output the response to the complete query and also to transition from the selection of the start-speaking token to selection of a start-listening token in response to the CDE finishing outputting the response to the complete query.

Of the apparatus, the DM may implement the user intention analysis by determining whether the audio input represents any of an intentional interruption of the user and an unintentional interruption of the user, and the DM may be configured to select one of the start-listening token, based on the user intention analysis resulting in a determination that the audio input represents a user intention to redirect a conversation with the SDS, and a continue-speaking token, based on the user intention analysis resulting in a determination that the audio input does not represent the user intention to redirect the conversation with the SDS.

Of the apparatus, the DM, based on selecting the start-speaking token as a result of the user intention analysis, may control a stop of an outputting of the response by the CDE and a restart of the listening process by the DM, and the DM, based on selecting the continue-speaking token as the result of the user intention analysis, may control the CDE to continue the outputting of the response by the CDE.

Of the apparatus, the DM may implement the user intention analysis by determining whether the audio input represents any of an intentional interruption of the user and an unintentional interruption of the user, and the DM may be configured to select one of a start-listening token, based on the user intention analysis resulting in a determination that the audio input represents a user intention to redirect a conversation with the SDS, and a continue-speaking token, based on the user intention analysis resulting in a determination that the audio input does not represent the user intention to redirect the conversation with the SDS.

Of the apparatus, the DM, based on selecting the start-speaking token as a result of the user intention analysis, may control a stop of an outputting of the response by the CDE and a restart of a listening process by the DM, and the DM, based on selecting the continue-speaking token as the result of the user intention analysis, may control the CDE to continue the outputting of the response by the CDE.

There is also provided a non-transitory computer readable medium storing a program causing a computer to execute a process, the process including: receiving an audio input, the audio input comprising any of at least part of a query spoken by a user and an other verbal input received by the SDS; implementing, by semantic voice activity detection (VAD) of a dialog manager (DM) trained as a first large language model (LLM), any of a user state detection and a user intention analysis, the DM being trained as the first LLM both to, as the user state detection, determine from the audio input whether the user has finished speaking the query and also to, as the user intention analysis, determine whether a user barge-in represented by the other verbal input requires a response; determining, by the DM and depending on a result of any of the user state detection and the user intention analysis, whether to activate at least part of a core dialog engine (CDE) to process the audio input, the CDE being trained as a second LLM that is larger than the first LLM; and controlling, by the CDE in response to being activated by the DM, output of a response to any of the query spoken by the user and the other verbal input as a result of the DM determining that the any of the query spoken by the user and the other verbal input requires response from the SDS.

Of the process which the program of the non-transitory computer readable medium causes the computer to execute, the DM may implement the user state detection by determining whether the audio input represents any of an incomplete query of the user and a complete query of the user, and the DM may be configured to select one of a continue-listening token, based on the user state detection resulting in a determination that the audio input represents the incomplete query, and a start-speaking token, based on the user state detection resulting in a determination that the audio input represents the complete query.

Of the process which the program of the non-transitory computer readable medium causes the computer to execute, the DM, based on selecting the continue-listening token as a result of the user state detection, may both control the SDS to, without activating the CDE, continue a listening process and cache any received queries during the listening process until at least the complete query is determined by the user state detection of the DM, and the DM, based on selecting the start-speaking token as the result of the user state detection, may both control activation of the CDE to process and output the response to the complete query and also to transition from the selection of the start-speaking token to selection of a start-listening token in response to the CDE finishing outputting the response to the complete query.

Of the process which the program of the non-transitory computer readable medium causes the computer to execute, the DM may implement the user intention analysis by determining whether the audio input represents any of an intentional interruption of the user and an unintentional interruption of the user, and the DM may be configured to select one of the start-listening token, based on the user intention analysis resulting in a determination that the audio input represents a user intention to redirect a conversation with the SDS, and a continue-speaking token, based on the user intention analysis resulting in a determination that the audio input does not represent the user intention to redirect the conversation with the SDS.

Of the process which the program of the non-transitory computer readable medium causes the computer to execute, the DM, based on selecting the start-speaking token as a result of the user intention analysis, may control a stop of an outputting of the response by the CDE and a restart of the listening process by the DM, and the DM, based on selecting the continue-speaking token as the result of the user intention analysis, may control the CDE to continue the outputting of the response by the CDE.

Of the process which the program of the non-transitory computer readable medium causes the computer to execute, the DM may implement the user intention analysis by determining whether the audio input represents any of an intentional interruption of the user and an unintentional interruption of the user, and the DM may be configured to select one of a start-listening token, based on the user intention analysis resulting in a determination that the audio input represents a user intention to redirect a conversation with the SDS, and a continue-speaking token, based on the user intention analysis resulting in a determination that the audio input does not represent the user intention to redirect the conversation with the SDS.

Of the process which the program of the non-transitory computer readable medium causes the computer to execute, the DM, based on selecting the start-speaking token as a result of the user intention analysis, may control a stop of an outputting of the response by the CDE and a restart of a listening process by the DM, and the DM, based on selecting the continue-speaking token as the result of the user intention analysis, may control the CDE to continue the outputting of the response by the CDE.

### BRIEF DESCRIPTION OF THE DRAWINGS

Further features, nature, and various advantages of the disclosed subject matter will be more apparent from the following detailed description and the accompanying drawings in which:

FIG. 1 is a simplified block diagram of a communication system in accordance with embodiments herein;

FIG. 2 illustrates a system architecture in accordance with embodiments herein;

FIG. 3 illustrates control tokens and their corresponding actions in accordance with embodiments herein;

FIG. 4 illustrates interactions between a dialogue manager and a core dialogue engine in accordance with embodiments herein;

FIG. 5 illustrates interactions in accordance with embodiments herein;

FIG. 6 illustrates a distribution of interaction scenarios in a generated full-duplex conversation dataset in accordance with embodiments herein; and

FIG. 7 is a schematic illustration in accordance with embodiments herein.

### DETAILED DESCRIPTION

The proposed features discussed below may be used separately or combined in any order. Further, the embodiments may be implemented by processing circuitry (e.g., one or more processors or one or more integrated circuits). In one example, the one or more processors execute a program that is stored in a non-transitory computer-readable medium.

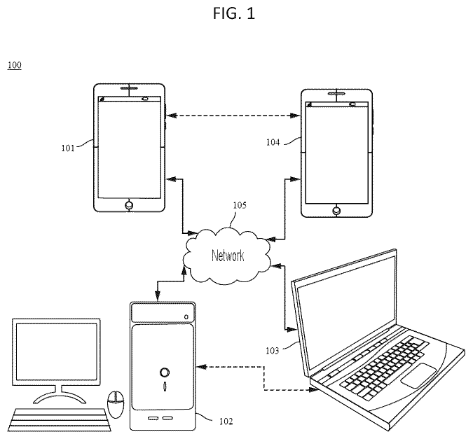

FIG. 1 illustrates a simplified block diagram of a communication system 100 according to an embodiment of the present disclosure. The communication system 100 may include at least two terminals 102 and 103 interconnected via a network 105. For unidirectional transmission of data, a first terminal 103 may code video data at a local location for transmission to the other terminal 102 via the network 105. The second terminal 102 may receive the coded data of the other terminal from the network 105, decode the coded data and display the recovered data. Unidirectional data transmission may be common in media serving applications and the like.

In FIG. 1, the terminals 101, 102, 103 and 104 may be illustrated as servers, personal computers and smart phones but the principles of the present disclosure are not so limited. Embodiments of the present disclosure find application with laptop computers, tablet computers, media players and/or dedicated equipment. The network 105 represents any number of networks that convey coded video data among the terminals 101, 102, 103 and 104, including for example wireline and/or wireless communication networks. The communication network 105 may exchange data in circuit-switched and/or packet-switched channels. Representative networks include telecommunications networks, local area networks, wide area networks and/or the Internet. For the purposes of the present discussion, the architecture and topology of the network 105 may be immaterial to the operation of the present disclosure unless explained herein below.

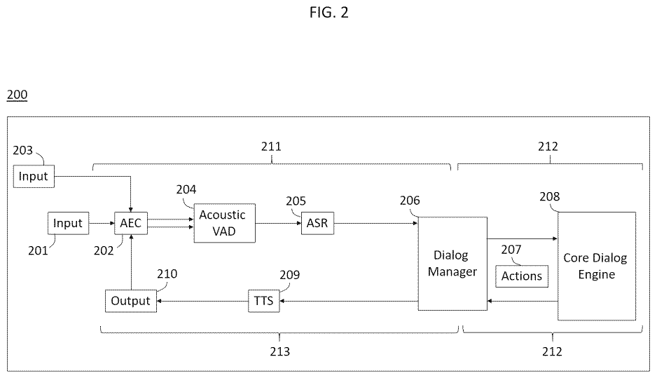

FIG. 2 illustrates a system architecture 200 in accordance with embodiments herein. Achieving seamless full-duplex communication in SDS requires accurately detecting and differentiating user activities, states, and intentions. However, real-time turn-taking remains challenging due to issues such as interfering speakers, ambiguous pauses, and unintentional interruptions:
Interfering Speakers: Background speech can cause ASR and dialogue management errors, leading to unintended activations or responses.
User Pauses & Hesitations: Silence alone does not indicate query completion, often resulting in premature responses or unnecessary delays.
Unintentional Interruptions: Acknowledgments, backchanneling, or speech directed at others may mistakenly halt SDS responses, disrupting conversational flow.

Addressing these challenges requires integrating both acoustic and semantic information for robust, context-aware full-duplex interaction, and FIG. 2 illustrates a system architecture 200 in accordance with embodiments herein that address those challenges.

To balance conversational quality, stability, and inference efficiency, embodiments herein, such as shown in FIG. 2, include a semantic voice activity detection (VAD) as a dialogue manager 206 (of which a dialogue manager may be referred to as “DM” herein) for full-duplex SDS.

While an acoustic VAD, such as the acoustic VAD 204, mitigates interference from background speakers using acoustic cues, the semantic VAD, the dialogue manager 206, leverages large language model (LLM) capabilities to detect user states and intentions based on semantic information.

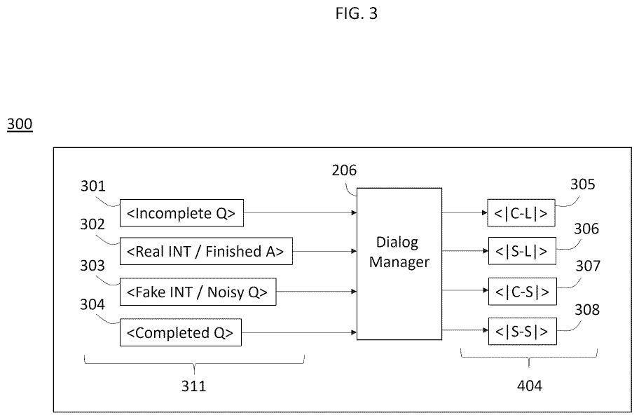

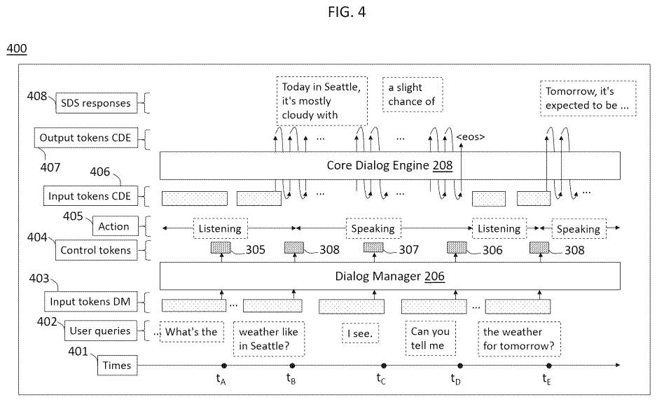

According to embodiments herein, the semantic VAD, the dialogue manager, represents the result of fine-tuning a smaller (0.5B) LLM, relative to a larger LLM, such as core dialog engine 208, on carefully designed full-duplex text conversations described further herein. The DM 206 predicts four control tokens (such as control tokens 404 of FIG. 4)—start-speaking (token 308, as in FIGS. 3 and 4 for example, also referred to as <|S-S|>), start-listening (token 306 also referred to as <|S-L|>), continue-speaking (token 307 also referred to as <|C-S|>), and continue-listening (token 305 also referred to as <|C-L|>) —to dynamically guide system interaction.

Operating at short intervals (at least relative to the core dialogue engine 208 (which may also be referred to as “CDE” herein) in practice according to one or more embodiments herein), the DM 206 enables real-time interaction management, distinguishing between intentional and unintentional barge-ins and detecting query completion to handle user pauses and hesitations. As such, and as the DM 206 is relatively lighter-weight, at least in terms of computational overhead as compared to the CDE 208, embodiments herein improve upon the technology by balancing DM performance and computational efficiency: that is, embodiments herein represent the technical advantages of leveraging the semantic understanding of LLMs, such as by the CDE 208, to enable precise dialogue management, while a lightweight LLM, such the DM 206, cuts computational costs. Independent DM and CDE optimization further ensures scalability according to embodiments herein.

As shown at least with the system architecture 200 shown in FIG. 2, the SDS of embodiments herein includes six key modules: an acoustic echo cancellation (AEC) module 202, an acoustic VAD module 204, and automatic speech recognition (ASR) module 205, a semantic VAD module (the dialog manager 206), an LLM serving as the core dialogue engine (CDE) 208, and text-to-speech (TTS) module 209. User speech is processed sequentially, with the first four modules, the AEC module 202, the acoustic VAD module 204, the ASR module 205, and the dialog manager 206, operating in short intervals to ensure real-time responsiveness. The CDE 208 is activated only when needed, thereby minimizing computational overhead.

That is, embodiments herein combine acoustic and semantic VAD to handle the previously mentioned challenges, enabling robust and seamless full-duplex interaction:
Acoustic VAD: the acoustic VAD 204 according to embodiments is speaker-and distance-aware, leveraging distance information and speaker embeddings (if provided) to isolate target speaker's activity and mitigate interference from other speakers.
Semantic VAD: the semantic VAD, serving as the DM 206, is implemented as a fine-tuned 0.5B LLM, and leverages the LLM's semantic understanding and contextual awareness to predict control tokens for dynamic turn-taking management. This enables effective handling of hesitations and accurate differentiation between real and fake interruptions.

Or in other words, the semantic VAD, the DM 206, according to embodiments herein introduce such improvements. That is, rather than necessarily improving question-answering capabilities of a larger LLM, such as the CDE 208, embodiments herein represent the result of training the DM 206 to follow structured rules and take appropriate actions in various full-duplex interaction scenarios through instruction tuning described below. As realized by the inventors to this disclosure, this approach requires only a small amount of high-quality data and minimal fine-tuning, making it efficient and practical. Unlike neural network (NN)-based DMs that rely on shallow features, such as frequency domain component analysis (e.g., acoustic frequencies), the fine-tuned LLM herein leverages semantic understanding for precise interaction management. Compared to integrating a DM directly into one or more CDE (larger models), embodiments herein represent the technical advantage of reducing computational inference costs by offloading frequent decisions, such as represented by the control tokens 404, to a lightweight LLM, the DM 206, while ensuring scalability through independent DM 206 and CDE 208 optimization.

Most user-SDS interactions follow a standard question-answering flow without interruptions. However, when interruptions occur, one or more embodiments herein represent the prioritization of user experience by allowing only user-initiated interruptions. For example, as shown in FIG. 2, there may be multiple acoustic inputs, such as an input 201 and an input 203 where one may be a user's intended query to the CDE 208 whereas the other input may be extraneous noise, other's speech, pauses in the user's speech, user's speech interruptions, etc., which may be determined by the DM 206 as not to interrupt the CDE 208 processing.

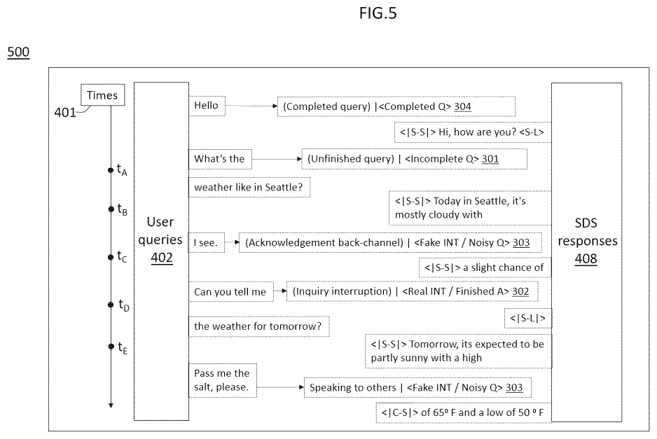

According to embodiments herein, the DM 206 enables the SDS to switch between speaking and listening modes by performing two key tasks, each associated with specific action tokens 311 (such as shown with the example 300 of FIG. 3) representing:
User State Detection: Determines whether the user has finished speaking, and tokens thereof:
   Query Incomplete (<Incomplete Q>301): The DM predicts <|Continue-Listening|>(<|C-L|>) 305, allowing the system, by the DM 206, to keep listening and cache historical queries until a complete query is identified.
   Query Complete (<Completed Q>304): The DM prompts the SDS to <|Start-Speaking|> (<|S-S|>) 308. Once the response is finished (either at the end of <|S-S|> 308 or <|C-S|>307), the SDS, by the DM 206, transitions to <|Start-Listening|> (<|S-L|>) 306 again and awaits further input.
User Intention Analysis: Determines whether a user barge-in requires a response.
   Intentional Interruption (Real INT or <Real INT/Finished A>302): If the user intends to redirect the conversation, the SDS, by the DM 206, determines the user stops speaking and switches to <|Start-Listening|> (<|S-L|>) 306. Examples include denial or discontent, further inquiries, and topic changes.
   Unintentional Interruption (Fake INT or <Fake INT/Noisy Q>303): If the interruption is non-disruptive, the SDS, by the DM 206, determined the user continues speaking with <|Continue-Speaking|> (<|C-S|>) 307. Examples include affirmative acknowledgments, back-channeling (e.g., uhuh, hmm, etc.), speech directed at someone else, and unrelated comments (e.g. “pass the salt” stated, as in example 500 of FIG. 5, in an overall context of a user asking the SDS about weather).

As shown in the example 400 of FIG. 4, the DM 2066 processes two primary inputs: (1) user query 402 tokens 403 from ASR 205 and (2) historical response tokens from the CDE 208. For clarity and due to space constraints, the historical response tokens are not explicitly depicted in FIG. 4 as DM 206 input. The DM 206 regulates interaction flow by analyzing these inputs to determine the next action 405.

According to embodiments, the DM 206 serves as the primary decision-maker, continuously managing listening and speaking states, while the CDE 208 focuses on generating high-quality responses when required. The CDE 208 is activated only when the DM predicts <|S-S|> 308, prompting the CDE 208 to perform standard LLM inference using past user queries and system responses, such as SDS responses 408. By relying on the DM 206 for frequent real-time decisions and selectively invoking the CDE 208, the system optimizes both computational efficiency and conversational quality, ensuring a scalable and effective full-duplex SDS.

Considering the core of the semantic VAD, the DM 206 according to embodiments herein, detailing of the data generation and the methodology for designing tailored prompts are described below.

Creating high-quality training data for the dialogue manager (DM) 206 involved annotating full-duplex conversations with the four control tokens (<Incomplete Q>301, <Real INT/Finished A>302, <Fake INT/Noisy Q>303, and <Completed Q>304), as shown in the example 500 of FIG. 5. As no public datasets met these criteria, an LLM API, Tencent Yuanbao Chat, was used to generate diverse and natural full-duplex dialogues.

To generate prompts to create full duplex conversation data, the following algorithm was designed and used. That is, prompts were designed to instruct LLMs on how to generate full-duplex conversation data annotated with control tokens. Each prompt included the following elements:
Objective: Generate a conversation transcript where the user can interrupt the assistant.
Assistant's Behavior: Specify the meanings of control to-kens and corresponding actions.
Output Format: Conversations are formatted as: {Round X (dialogue type); User: <user's query or barge-in>; Sys: <assistant's response with control tokens>}.
Custom Instructions: Specify the number of QA rounds, topic, and speaking style. For example: “Please generate 5 rounds of conversation. The user initiates the conversation with a topic related to travel, speaking in a casual and conversational style. The assistant maintains a friendly tone and references the previous context.”

The topic pool covered 200 common conversation themes (e.g., weather, travel, restaurants), while the speaking style pool included 10 user personas. Topics and styles were randomly selected, with probabilities adjusted for realism.

The data preparation included four stages: data generation, cleaning, post-processing, and augmentation. Full-duplex conversations were generated using 20,000 prompts with Tencent Yuanbao chat, but it was found that not all generated data aligned fully with the intended structure due to limited command-following abilities. To address this, strict data cleaning was applied, along with filtering malformed outputs and incorrect control tokens, resulting in a retention rate of 60%. Given this, an alternative strategy was also adopted: first generating standard QA (question/answer) dialogues, which LLMs handle more effectively, and then introducing various interaction patterns via controlled post-processing. The final training dataset combined conversations from both strategies.

The data was further augmented by modifying the punctuation at the end of user queries to better match the ASR output (for example, although ASR may detect a word, the ASR may not detect the correct intonation or intended declarative, exclamatory, or questioning for example).

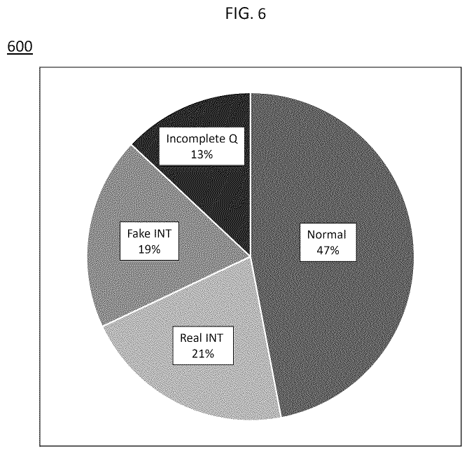

The final dataset included 11,990 conversations with 80,338 dialogue rounds covering diverse interaction scenarios, with a breakdown shown in example 600 of FIG. 6. Furthermore, extreme cases were examined with a high proportion (over 50%) or exclusively real/fake interruptions or incomplete queries, which led to overfitting and degraded performance, reinforcing the need for balanced training data. To mitigate potential degradation of the base LLM's capabilities, the corresponding uninterrupted dialogues were included alongside full-duplex samples in the training set.

For fine-tuning, a small version of Hunyuan, 0.5B-dense-8k model (An open-source mixture of experts (moe) model with 52 billion activated parameters by Tencent), on the curated dataset. The initial study focused on Chinese dialogues and the dataset exclusively included Chinese full-duplex dialogues. The training followed standard LLM fine-tuning with four added control tokens described above, running for 1,500 steps with a batch size of 128 and a learning rate of 0.001, linearly decayed to 0.0001 for stable optimization.

As such, there is provided by embodiments herein a semantic VAD-based dialogue manager, the DM 206, for full-duplex SDS, leveraging a fine-tuned 0.5B LLM to regulate turn-taking through control tokens. Such embodiments effectively distinguish between intentional and unintentional barge-ins, detects query completion, and reduces computational overhead by selectively invoking the core dialogue engine (CDE) 208. Experimental results demonstrate improved interaction fluidity and intent recognition.

And with such trained DM 206, as shown in FIG. 2, distinguishing between intended and unintended ones of the inputs 201 and 203 to the CDE 208 is achieved according to embodiments without invoking the more computationally taxing CDE 208 processing. The DM 206 may engage in “listening” 211, and, when activated by the DM 206, the CDE may engage in “thinking” 212, after which the system may engage in “speaking” 213 as the output 210 or the like. The actions 207 represent ones of the specific action tokens 311.

As in FIG. 3, the DM 206 may determine the <Incomplete Q>301 to result in the <|C-L|>305, the <Real INT/Finished A>302 to result in the <|S-L|>306, the <Fake INT / Noisy Q>303 to result in the <|C-S|>307, and the <Completed Q>304 to result in the <|S-S|>308. Such actions, e.g., action 405 of FIG. 4, may be used at any of the times 401 determined appropriate by the DM 206 to take ones of the user queries 402 and corresponding input tokens to the DM 403 and output such control tokens 404. By such features input tokens to CDE 406 may be provided until the CDE 208 determines an end of service (eos) token, such as in response to the inquiry interruption or resulting <|S-L|>306 to, by the CDE, provide its output tokens 407 and SDS responses 408, such as the output 210.

By the novel DM 206 being both lighter-weight, in terms of computational overhead as compared to the relatively larger and more intensive CDE 208, overall computational costs are reduced and therefore technical efficiency of the overall system is improved according to embodiments herein while providing enhancements. For example, as in FIG. 5, rather than the SDS responses 408 being interrupted by the “I see” (backchannelling) remark, the DM 206 allows continuance of output from the CDE 208 of a response to an initial one of user queries 402 while, without using CDE 208 computational resources, still listening for any of the features illustrated in FIG. 3 and taking respective actions thereon. As such, realistic full duplex communication, as illustrated in FIGS. 4 and 5, is achieved by embodiments herein without detriment to, and instead improving, computational overhead.

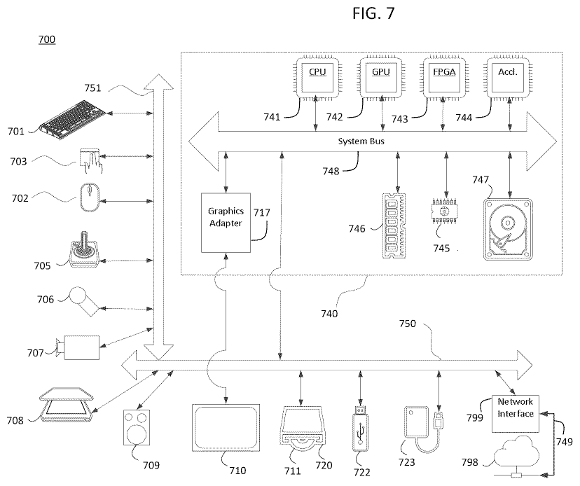

The techniques described above, can be implemented as computer software using computer-readable instructions and physically stored in one or more computer-readable media or by a specifically configured one or more hardware processors. For example, FIG. 7 shows a computer system 700 suitable for implementing certain embodiments of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 7 for computer system 700 are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system 700.

Computer system 700 may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard 701, mouse 702, trackpad 703, touch screen 710, joystick 705, microphone 706, scanner 708, camera 707.

Computer system 700 may also include certain human interface output devices. Such human interface output devices may be stimulating the senses of one or more human users through, for example, tactile output, sound, light, and smell/taste. Such human interface output devices may include tactile output devices (for example tactile feedback by the touch-screen 710, or joystick 705, but there can also be tactile feedback devices that do not serve as input devices), audio output devices (such as: speakers 709, headphones (not depicted)), visual output devices (such as screens 710 to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses (not depicted), holographic displays and smoke tanks (not depicted)), and printers (not depicted).

Computer system 700 can also include human accessible storage devices and their associated media such as optical media including CD/DVD ROM/RW 720 with CD/DVD 711 or the like media, thumb-drive 722, removable hard drive or solid state drive 723, legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system 700 can also include interface 799 to one or more communication networks 798. Networks 798 can for example be wireless, wireline, optical. Networks 798 can further be local, wide-area, metropolitan, vehicular and industrial, real-time, delay-tolerant, and so on. Examples of networks 798 include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks 798 commonly require external network interface adapters that attached to certain general-purpose data ports or peripheral buses (750 and 751) (such as, for example USB ports of the computer system 700; others are commonly integrated into the core of the computer system 700 by attachment to a system bus as described below (for example Ethernet interface into a PC computer system or cellular network interface into a smartphone computer system). Using any of these networks 798, computer system 700 can communicate with other entities. Such communication can be uni-directional, receive only (for example, broadcast TV), uni-directional send-only (for example CANbusto certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core 740 of the computer system 700.

The core 740 can include one or more Central Processing Units (CPU) 741, Graphics Processing Units (GPU) 742, a graphics adapter 717, specialized programmable processing units in the form of Field Programmable Gate Areas (FPGA) 743, hardware accelerators for certain tasks 744, and so forth. These devices, along with Read-only memory (ROM) 745, Random-access memory 746, internal mass storage such as internal non-user accessible hard drives, SSDs, and the like 747, may be connected through a system bus 748. In some computer systems, the system bus 748 can be accessible in the form of one or more physical plugs to enable extensions by additional CPUs, GPU, and the like. The peripheral devices can be attached either directly to the core's system bus 748, or through a peripheral bus 751. Architectures for a peripheral bus include PCI, USB, and the like.

CPUs 741, GPUs 742, FPGAs 743, and accelerators 744 can execute certain instructions that, in combination, can make up the aforementioned computer code. That computer code can be stored in ROM 745 or RAM 746. Transitional data can be also be stored in RAM 746, whereas permanent data can be stored for example, in the internal mass storage 747. Fast storage and retrieval to any of the memory devices can be enabled through the use of cache memory, that can be closely associated with one or more CPU 741, GPU 742, mass storage 747, ROM 745, RAM 746, and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, an architecture corresponding to computer system 700, and specifically the core 740 can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core 740 that are of non-transitory nature, such as core-internal mass storage 747 or ROM 745. The software implementing various embodiments of the present disclosure can be stored in such devices and executed by core 740. A computer-readable medium can include one or more memory devices or chips, according to particular needs. The software can cause the core 740 and specifically the processors therein (including CPU, GPU, FPGA, and the like) to execute particular processes or particular parts of particular processes described herein, including defining data structures stored in RAM 746 and modifying such data structures according to the processes defined by the software. In addition or as an alternative, the computer system can provide functionality as a result of logic hardwired or otherwise embodied in a circuit (for example: accelerator 744), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method of a speech detection system (SDS), the method being implemented by one of more hardware processors and comprising:
receiving an audio input, the audio input comprising any of at least part of a query spoken by a user and an other verbal input received by the SDS;
implementing, by semantic voice activity detection (VAD) of a dialog manager (DM) trained as a first large language model (LLM), any of a user state detection and a user intention analysis, the DM being trained as the first LLM both to, as the user state detection, determine from the audio input whether the user has finished speaking the query and also to, as the user intention analysis, determine whether a user barge-in represented by the other verbal input requires a response;
determining, by the DM and depending on a result of any of the user state detection and the user intention analysis, whether to activate at least part of a core dialog engine (CDE) to process the audio input, the CDE being trained as a second LLM that is larger than the first LLM; and
controlling, by the CDE in response to being activated by the DM, output of a response to any of the query spoken by the user and the other verbal input as a result of the DM determining that the any of the query spoken by the user and the other verbal input requires response from the SDS.

2. The method according to claim 1, wherein
the DM implements the user state detection by determining whether the audio input represents any of an incomplete query of the user and a complete query of the user, and
the DM is configured to select one of a continue-listening token, based on the user state detection resulting in a determination that the audio input represents the incomplete query, and a start-speaking token, based on the user state detection resulting in a determination that the audio input represents the complete query.

3. The method according to claim 2, wherein
the DM, based on selecting the continue-listening token as a result of the user state detection, controls the SDS to, without activating the CDE, continue a listening process and cache any received queries during the listening process until at least the complete query is determined by the user state detection of the DM, and
the DM, based on selecting the start-speaking token as the result of the user state detection, both controls activation of the CDE to process and output the response to the complete query and also to transition from the selection of the start-speaking token to selection of a start-listening token in response to the CDE finishing outputting the response to the complete query.

4. The method according to claim 3, wherein
the DM implements the user intention analysis by determining whether the audio input represents any of an intentional interruption of the user and an unintentional interruption of the user, and
the DM is configured to select one of the start-listening token, based on the user intention analysis resulting in a determination that the audio input represents a user intention to redirect a conversation with the SDS, and a continue-speaking token, based on the user intention analysis resulting in a determination that the audio input does not represent the user intention to redirect the conversation with the SDS.

5. The method according to claim 4, wherein
the DM, based on selecting the start-speaking token as a result of the user intention analysis, controls a stop of an outputting of the response by the CDE and a restart of the listening process by the DM, and
the DM, based on selecting the continue-speaking token as the result of the user intention analysis, controls the CDE to continue the outputting of the response by the CDE.

6. The method according to claim 1, wherein
the DM implements the user intention analysis by determining whether the audio input represents any of an intentional interruption of the user and an unintentional interruption of the user, and
the DM is configured to select one of a start-listening token, based on the user intention analysis resulting in a determination that the audio input represents a user intention to redirect a conversation with the SDS, and a continue-speaking token, based on the user intention analysis resulting in a determination that the audio input does not represent the user intention to redirect the conversation with the SDS.

7. The method according to claim 6, wherein
the DM, based on selecting the start-speaking token as a result of the user intention analysis, controls a stop of an outputting of the response by the CDE and a restart of a listening process by the DM, and
the DM, based on selecting the continue-speaking token as the result of the user intention analysis, controls the CDE to continue the outputting of the response by the CDE.

8. An apparatus of a speech detection system (SDS), the apparatus comprising:
one or more memories configured to store computer program code; and
one or more processors configured to access the computer program code and operate as instructed by the computer program code, the computer program code including:
receiving code configured to cause the one or more processors to receive an audio input, the audio input comprising any of at least part of a query spoken by a user and an other verbal input received by the SDS;
implementing code configured to cause the one or more processors to, by semantic voice activity detection (VAD) of a dialog manager (DM) trained as a first large language model (LLM), implement any of a user state detection and a user intention analysis, the DM being trained as the first LLM both to, as the user state detection, determine from the audio input whether the user has finished speaking the query and also to, as the user intention analysis, determine whether a user barge-in represented by the other verbal input requires a response;
determining code configured to cause the one or more processors to, by the DM and depending on a result of any of the user state detection and the user intention analysis, determine whether to activate at least part of a core dialog engine (CDE) to process the audio input, the CDE being trained as a second LLM that is larger than the first LLM; and
controlling code configured to cause the one or more processors to, by the CDE in response to being activated by the DM, control output of a response to any of the query spoken by the user and the other verbal input as a result of the DM determining that the any of the query spoken by the user and the other verbal input requires response from the SDS.

9. The apparatus according to claim 8, wherein
the DM implements the user state detection by determining whether the audio input represents any of an incomplete query of the user and a complete query of the user, and
the DM is configured to select one of a continue-listening token, based on the user state detection resulting in a determination that the audio input represents the incomplete query, and a start-speaking token, based on the user state detection resulting in a determination that the audio input represents the complete query.

10. The apparatus according to claim 9, wherein
the DM, based on selecting the continue-listening token as a result of the user state detection, controls the SDS to, without activating the CDE, continue a listening process and cache any received queries during the listening process until at least the complete query is determined by the user state detection of the DM, and
the DM, based on selecting the start-speaking token as the result of the user state detection, both controls activation of the CDE to process and output the response to the complete query and also to transition from the selection of the start-speaking token to selection of a start-listening token in response to the CDE finishing outputting the response to the complete query.

11. The apparatus according to claim 10, wherein
the DM implements the user intention analysis by determining whether the audio input represents any of an intentional interruption of the user and an unintentional interruption of the user, and
the DM is configured to select one of the start-listening token, based on the user intention analysis resulting in a determination that the audio input represents a user intention to redirect a conversation with the SDS, and a continue-speaking token, based on the user intention analysis resulting in a determination that the audio input does not represent the user intention to redirect the conversation with the SDS.

12. The apparatus according to claim 11, wherein
the DM, based on selecting the start-speaking token as a result of the user intention analysis, controls a stop of an outputting of the response by the CDE and a restart of the listening process by the DM, and
the DM, based on selecting the continue-speaking token as the result of the user intention analysis, controls the CDE to continue the outputting of the response by the CDE.

13. The apparatus according to claim 8, wherein
the DM implements the user intention analysis by determining whether the audio input represents any of an intentional interruption of the user and an unintentional interruption of the user, and
the DM is configured to select one of a start-listening token, based on the user intention analysis resulting in a determination that the audio input represents a user intention to redirect a conversation with the SDS, and a continue-speaking token, based on the user intention analysis resulting in a determination that the audio input does not represent the user intention to redirect the conversation with the SDS.

14. The apparatus according to claim 13, wherein
the DM, based on selecting the start-speaking token as a result of the user intention analysis, controls a stop of an outputting of the response by the CDE and a restart of a listening process by the DM, and
the DM, based on selecting the continue-speaking token as the result of the user intention analysis, controls the CDE to continue the outputting of the response by the CDE.

15. A non-transitory computer readable medium storing a program causing a computer to execute a process, the process comprising:
receiving an audio input, the audio input comprising any of at least part of a query spoken by a user and an other verbal input received by the SDS;
implementing, by semantic voice activity detection (VAD) of a dialog manager (DM) trained as a first large language model (LLM), any of a user state detection and a user intention analysis, the DM being trained as the first LLM both to, as the user state detection, determine from the audio input whether the user has finished speaking the query and also to, as the user intention analysis, determine whether a user barge-in represented by the other verbal input requires a response;
determining, by the DM and depending on a result of any of the user state detection and the user intention analysis, whether to activate at least part of a core dialog engine (CDE) to process the audio input, the CDE being trained as a second LLM that is larger than the first LLM; and
controlling, by the CDE in response to being activated by the DM, output of a response to any of the query spoken by the user and the other verbal input as a result of the DM determining that the any of the query spoken by the user and the other verbal input requires response from the SDS.

16. The non-transitory computer readable medium according to claim 15, wherein
the DM implements the user state detection by determining whether the audio input represents any of an incomplete query of the user and a complete query of the user, and
the DM is configured to select one of a continue-listening token, based on the user state detection resulting in a determination that the audio input represents the incomplete query, and a start-speaking token, based on the user state detection resulting in a determination that the audio input represents the complete query.

17. The non-transitory computer readable medium according to claim 16, wherein
the DM, based on selecting the continue-listening token as a result of the user state detection, controls the SDS to, without activating the CDE, continue a listening process and cache any received queries during the listening process until at least the complete query is determined by the user state detection of the DM, and
the DM, based on selecting the start-speaking token as the result of the user state detection, both controls activation of the CDE to process and output the response to the complete query and also to transition from the selection of the start-speaking token to selection of a start-listening token in response to the CDE finishing outputting the response to the complete query.

18. The non-transitory computer readable medium according to claim 17, wherein
the DM implements the user intention analysis by determining whether the audio input represents any of an intentional interruption of the user and an unintentional interruption of the user, and
the DM is configured to select one of the start-listening token, based on the user intention analysis resulting in a determination that the audio input represents a user intention to redirect a conversation with the SDS, and a continue-speaking token, based on the user intention analysis resulting in a determination that the audio input does not represent the user intention to redirect the conversation with the SDS.

19. The non-transitory computer readable medium according to claim 18, wherein
the DM, based on selecting the start-speaking token as a result of the user intention analysis, controls a stop of an outputting of the response by the CDE and a restart of the listening process by the DM, and
the DM, based on selecting the continue-speaking token as the result of the user intention analysis, controls the CDE to continue the outputting of the response by the CDE.

20. The non-transitory computer readable medium according to claim 15, wherein
the DM implements the user intention analysis by determining whether the audio input represents any of an intentional interruption of the user and an unintentional interruption of the user, and
the DM is configured to select one of a start-listening token, based on the user intention analysis resulting in a determination that the audio input represents a user intention to redirect a conversation with the SDS, and a continue-speaking token, based on the user intention analysis resulting in a determination that the audio input does not represent the user intention to redirect the conversation with the SDS.
